(19) United States
(12) Patent Application Publication
(10) Pub. No.: US 2016/0247121 A1
(43) Pub. Date: Aug. 25, 2016

(54) METHOD AND SYSTEM FOR SCHEDULING OF TIME-RESTRICTED SHARED ASSETS

(71) Applicant: INNOVATIVE TIME SOLUTIONS INC., Vancouver (CA)

(72) Inventors: Christopher Mark Simpson, West Vancouver (CA); Jun Yin, Toronto (CA)

(21) Appl. No.: 15/025,723

(22) PCT Filed: Sep. 30, 2014
(86) PCT No.: PCT/CA2014/050935

§ 371 Date: Mar. 29, 2016

Related U.S. Application Data
(60) Provisional application No. 61/884,811, filed on Sep. 30, 2013.

(51) Int. Cl. G06Q 10/10

(52) U.S. Cl. CPC G06Q 10/1093

(57) ABSTRACT

The system allows an employee/individual/asset to manage availability and schedules with multiple stakeholders from one log in, simultaneously. Stakeholders might include employers, organizations, departments, groups, units, friends, family and those with whom one might associate. A social network based on the sharing of availability and time with others is provided. Employees have a single source to manage availability or unavailability with multiple organizations simultaneously from one log in. Other solutions do not currently allow for a single log in for employees to connect with more than one employer using the same solution. The method allows for a single log in for employees to connect with more than one employer. The approximate distance away of every contact using a mobile app is provided so managers can see how far away an employee is in the event they have not shown up for a shift or when considering who to call in for a last minute shift.

### CROSS REFERENCE TO RELATED APPLICATION

The present application claims the benefits, under 35 U.S.C. §119(e), of U.S. Provisional Application Ser. No. 61/884,811 filed Sep. 30, 2013 entitled “Method and System for Scheduling of Time-Restricted Assets” which is incorporated herein by this reference.

### TECHNICAL FIELD

The invention relates to systems for scheduling time-restricted shared assets such as employees.

### BACKGROUND

According to existing scheduling systems, an individual maintains a personal calendar for recording the individual's daily schedule on a time basis. Other individuals or organizations also maintain their own personal calendars for recording their schedule on a time basis. Some of the calendared events will overlap as among the various individuals and organizations. Such personal calendars may be computer based, or paper based or a combination of both. They are not in general coordinated among themselves. For computer based personal calendars there is limited ability to manage different levels of access to the information in the calendar. There is no integration with workplace scheduling and no concept of immediate availability. The computer applications are Email based, with no ability to receive push notifications via a mobile application and there is no ability to engage in a social network based on time scheduling.

The growing importance of part-time employment and casual labour results in many workers holding multiple jobs which creates scheduling difficulties. Employees with multiple jobs need to maintain multiple accounts and need to maintain availability with each employer separately. The employee cannot share availability with multiple employers or socially. Some existing systems allow users to set only their unavailability, thus scheduling time off versus time on, which requires extra effort if a user is only available for small windows of time.

There is therefore a need for a scheduling system which provides immediate information on the employee's/asset's availability and reduces scheduling conflicts when multiple stakeholders are trying to schedule shared assets simultaneously.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention provides a system that allows an employee/individual/asset to manage availability and schedules with multiple stakeholders from one log in, simultaneously. Stakeholders might include employers, organizations, departments, groups, units, friends, family and those with whom one might associate. A social network based on the sharing of availability and time with others is provided.

According to one embodiment, there is provided a computer-implemented method, and computer program for carrying out the method, of scheduling, over a computer network, a time-limited asset, such as an employee, among a plurality of users of the asset, such as employers, where the asset and plurality of asset users have access to the internet, the method comprising:
i) providing a scheduling server accessible to the internet and to a web server for displaying information to the asset and asset users;
ii) providing a database for storing scheduling information;
iii) the scheduling server maintaining a scheduling calendar for the asset which is accessible to the asset, has controlled access to the asset users, by receiving scheduling information from the asset;
iv) the scheduling server receiving from one of the plurality of asset users a scheduling invitation;
v) the scheduling server saving the invitation to the database;
vi) the scheduling server communicating the invitation to the asset;
vii) the scheduling server receiving from the asset an acceptance or refusal of the invitation;
viii) the scheduling server updating the asset's calendar and informing one of the plurality of asset users of the scheduling;
ix) the server repeating steps iv) through viii) for additional invitations for said asset scheduling;
   wherein more than one asset user can access said asset's availability on the calendar simultaneously. The asset may be an employee and the asset users a plurality of employers. The employee may access the system using a mobile application having GPS capability and the approximate distance away of the employee from the employer may be displayed to the employer. The employee may provide an indication of current immediate availability or lack of immediate availability as well as future availability on the calendar which is accessible to the employers.

The present invention allows employees a single source to manage availability or unavailability with multiple organizations simultaneously from one log in. Other solutions do not currently allow for a single log in for employees to connect with more than one employer using the same solution. The method disclosed herein however does allow for a single log in for employees to connect with more than one employer.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic drawing of a computer network for implementing the system of the invention;

FIGS. 2 and 3 are schematic diagrams illustrating the method and system of the invention;

FIG. 4 is a schematic diagram illustrating some typical API calls.

FIG. 5 through 18 are screen shots illustrating an embodiment.

FIG. 19 through 28 are wireframes illustrating an embodiment for use as a mobile device application.

FIGS. 29 and 30 are flowcharts illustrating the user's interaction with the system for a mobile application and web-based application respectively.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

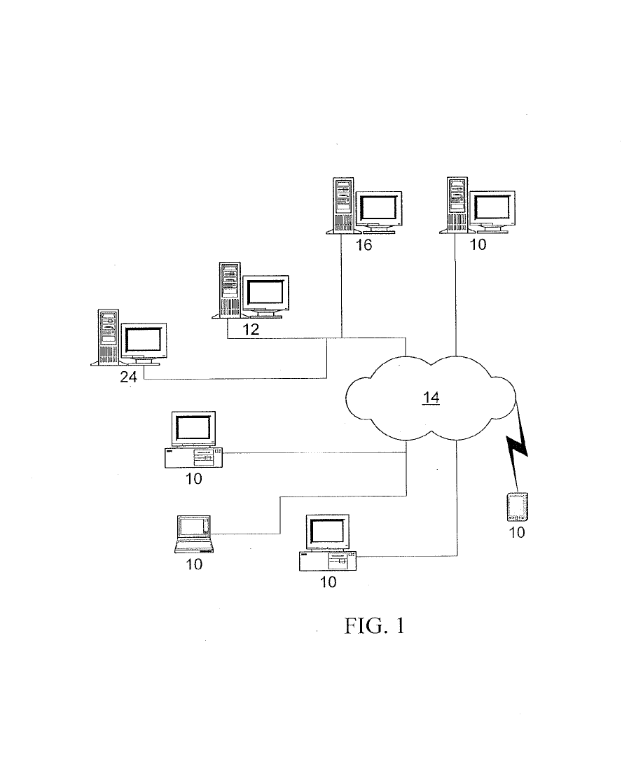

With reference to FIG. 1, one or more users, whether individuals or organizations, have access to the Internet 14 via remote client computer terminals 10, whether desktop, laptop, wireless, wired, smartphone, tablet etc. using an Internet Browser application or native mobile application. The scheduling website is hosted on web server 12 accessible to the Internet. The system is operated by a scheduling server 16. Database storage for the servers 12, 16 may be housed separately at 24. A user at terminal 10, who may be an employee of an organization, employed on a part-time or full-time basis, or an employer, accesses the website 12 by pointing his or her browser at the system website URL.

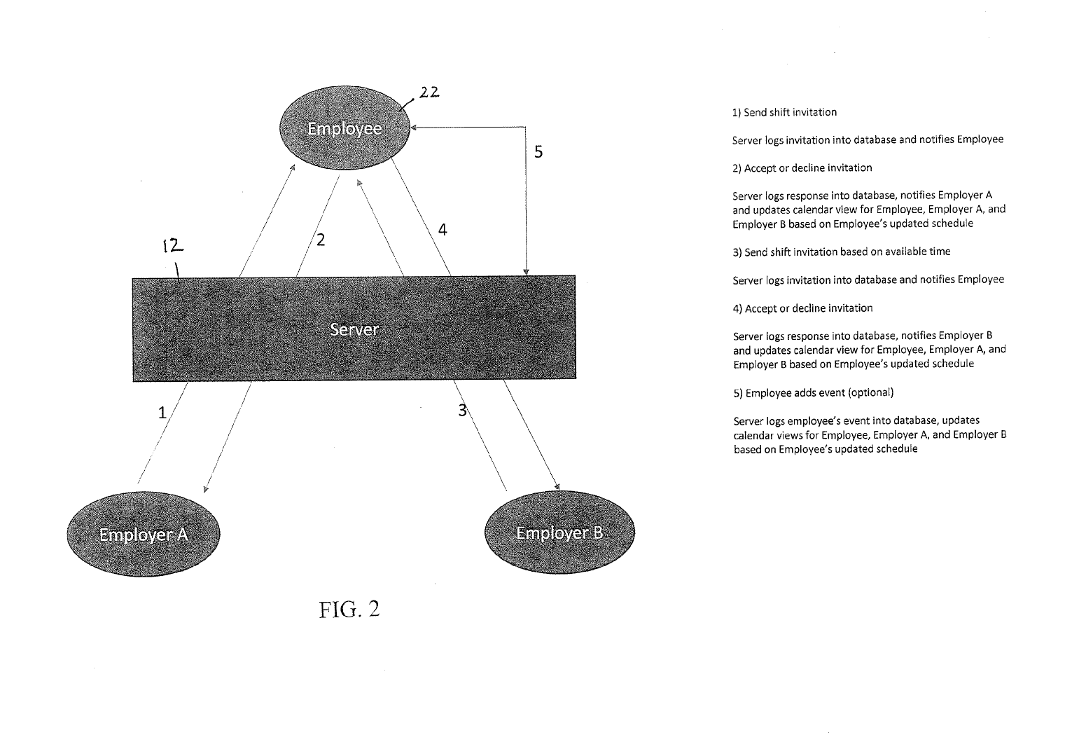

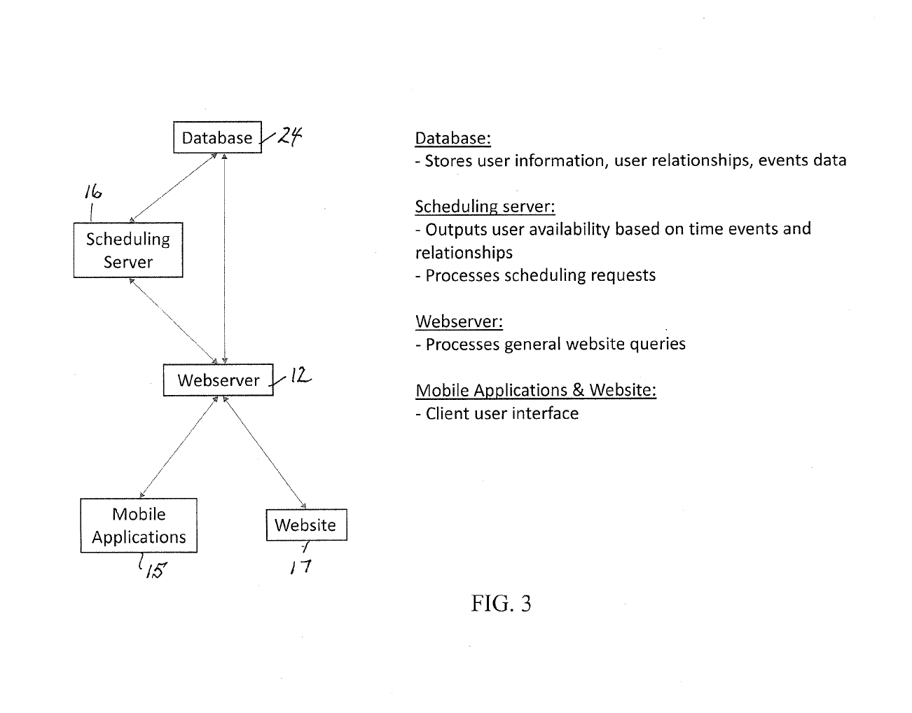

FIGS. 2 and 3 illustrate schematically how the invention may be used by two Employers A and B to schedule a common full or part-time employee 22 using their own computer-implemented staff scheduling application which may be a preferred scheduling application for improved compatibility with the invention. Employers A and B and employee 22 have access to all employer scheduling through a single web server 12, using a mobile application 15 as the client user interface, or a web browser 17 accessing the scheduling web site. The web server 12 processes the client queries and directs scheduling requests to the scheduling server 16, which processes such requests using data in database 24 and outputs user availability based on time events and relationships. Webserver 12 and scheduling server 16 may operate as a single server. User information, user relationships and events data are stored in database 24 for access by the web server 12 and scheduling server 16.

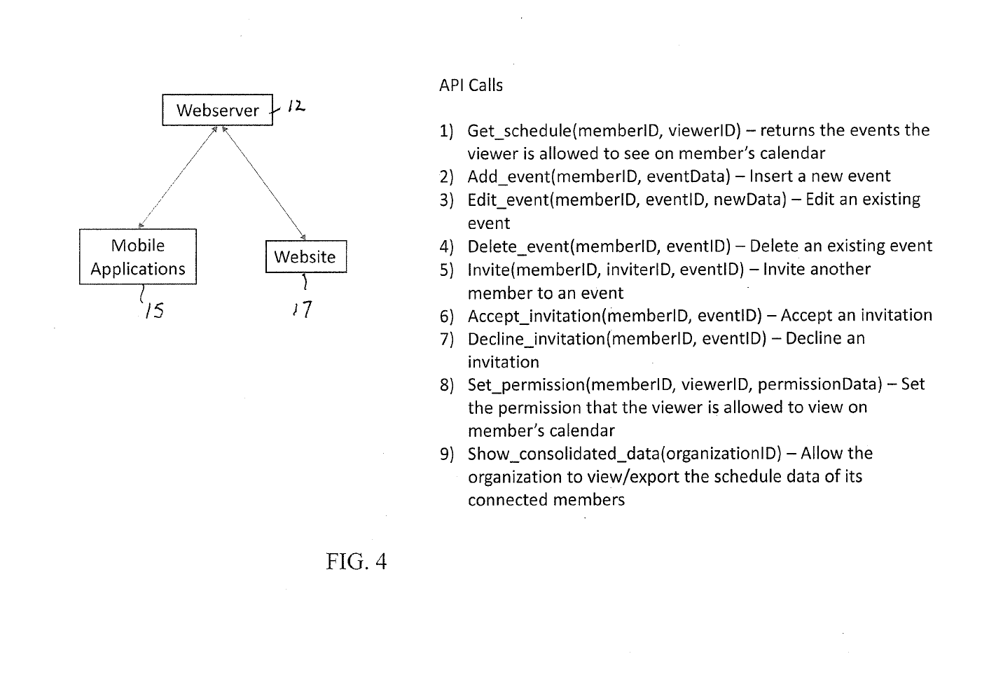

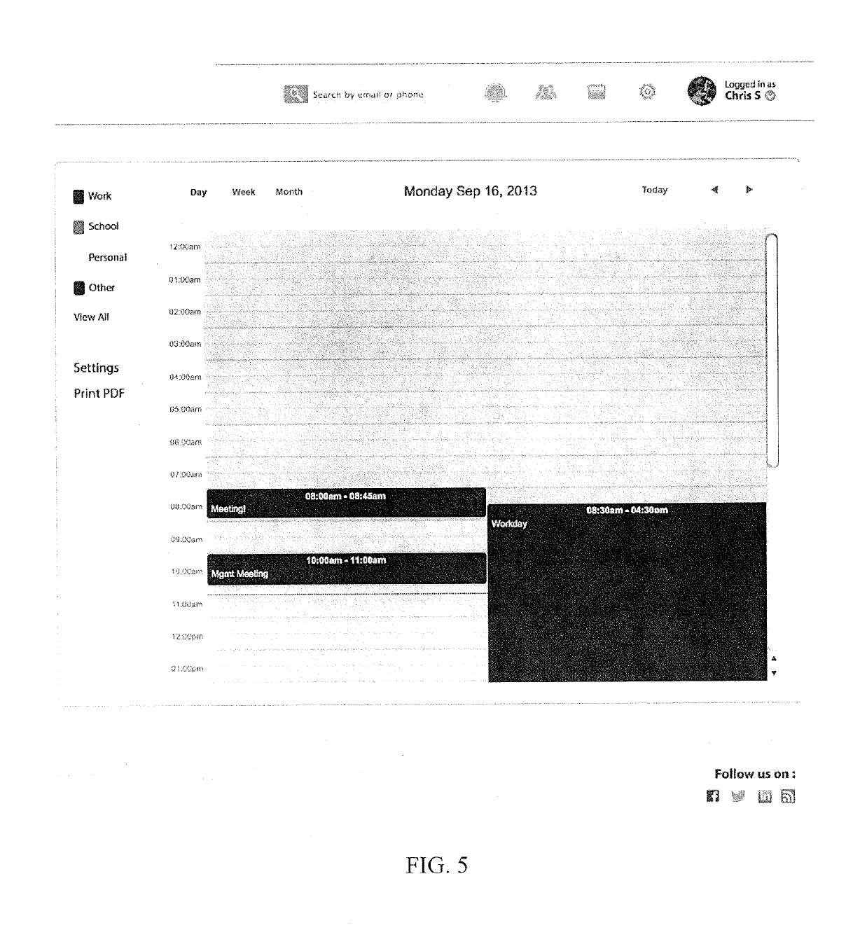

FIG. 4 illustrates the API (Application Programming Interface) calls which may be made by the web server 12 to the scheduling server 16 when a user interfaces with the website and requests certain actions, namely 1) viewing a member's calendar; 2) inserting a new event in a calendar; 3) editing an existing event in a calendar; 4) deleting an existing event from a calendar; 5) inviting a member to an event; 6) accepting an invitation; 7) declining an invitation; 8) setting permissions for a member's calendar and 9) allowing an organization to view or export the schedule data of its connected members. There are a many more API calls and FIG. 4 illustrates one example. Another example equivalent to the API calls in FIG. 4 is as follows:

1) GET /users/{user_id}/events
2) POST /events
3) PUT /events/{event_id}
4) DELETE /events/{event_id}
5) may be done automatically when adding/editing events
6) POST /eventinvite/{id}
7) POST /eventinvite/{id}
8) PUT /permissions/{id}

According to one embodiment, employees and employers each sign up for the system as Members, whereby the employer designates one or more of the employer's staff to maintain its calendar on the system and send invitations to employees. In a second embodiment each participating Employer Organization may use a computer-implemented staff scheduling application, the preferred Staff Scheduling solution having prescribed features as follows. It can set up the organization's structure and rules via an Organization Manager. Organizations create Units (locations) within the Organization, create Groups (departments or service areas) within Units, and create Positions, which are assigned to Groups. Positions can be defined with rules on pay rates, maximum number of hours that can be worked in a given week and in a given day. In addition, Organizations can set up Managers and assign them to Units, allowing them to access, manage and schedule employees using the Staff Scheduler.

Organizations and Managers can then invite Employees to connect with the Organization via the System Web Server 12, assign Employees to Positions, set pay rates, set rules around scheduling and manage an Employee's qualifications. Organizations can additionally set rules as to how shifts may be swapped (with or without Manager approval), manage Employee performance/qualification ratings, shift durations, establish weekly labour budgets on a per position/group/unit basis and run a variety of reports. Once the Organization is set up with its Units, Groups, Positions, Managers, Employees and rules, Managers can create, manage, modify and publish schedules. If an Organization is connected to an Employee via the System Web Server 12, it can post work time blocks to the Employees schedule. The Employee must accept or decline work time blocks to confirm receipt of his/her work schedule.

The Employers' own scheduling solution integrate with the scheduling server via the API using similar calls to those described in FIG. 4. As shown in FIG. 2 Employer A or B scheduling solutions communicate with the Server via the API. The Employer's solution can request and receive the availability of an employee and can send event(s) requests to the employee, the employee accepts or declines the event(s). If accepted, the event(s) populate his/her calendar. If declined, they do not populate the calendar. Additional API calls are provided for when an employee wants to send a “take my shift” request, pick up a shift and/or notify that they are sick, for example.

The invention, described as follows, allows employees a single source to manage availability or unavailability with multiple organizations simultaneously from one log in. Previously a single log in for employees to connect with more than one employer was not available. The invention does allow for a single log in for employees to connect with more than one employer using different scheduling solutions via an API.

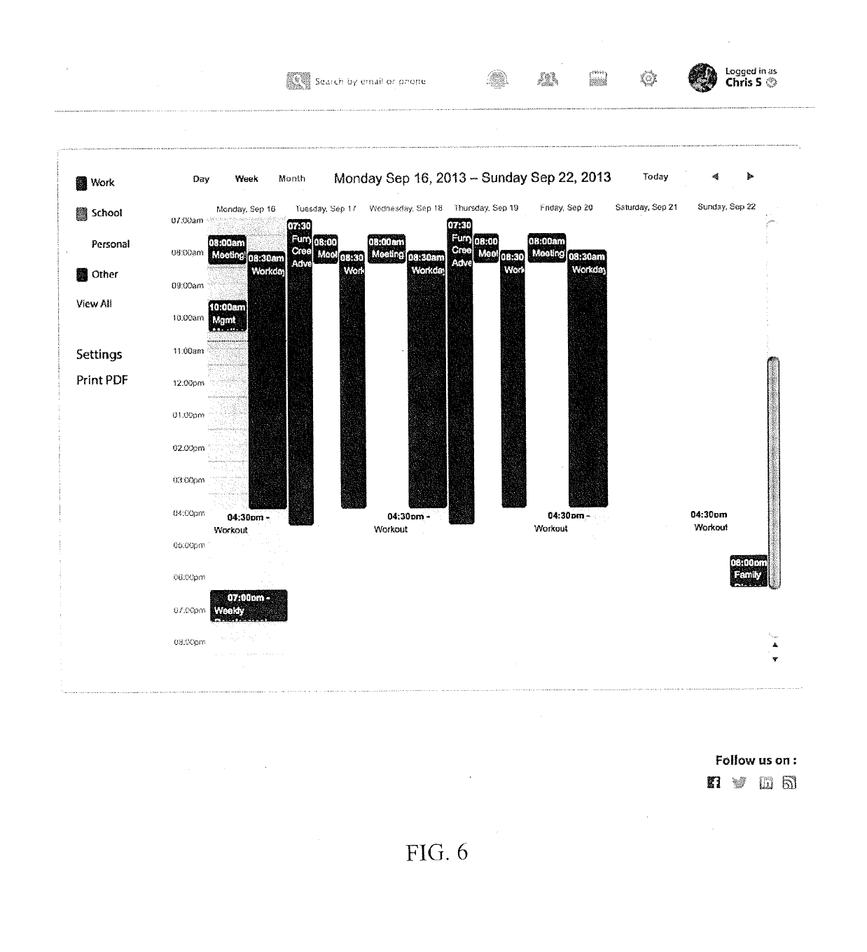

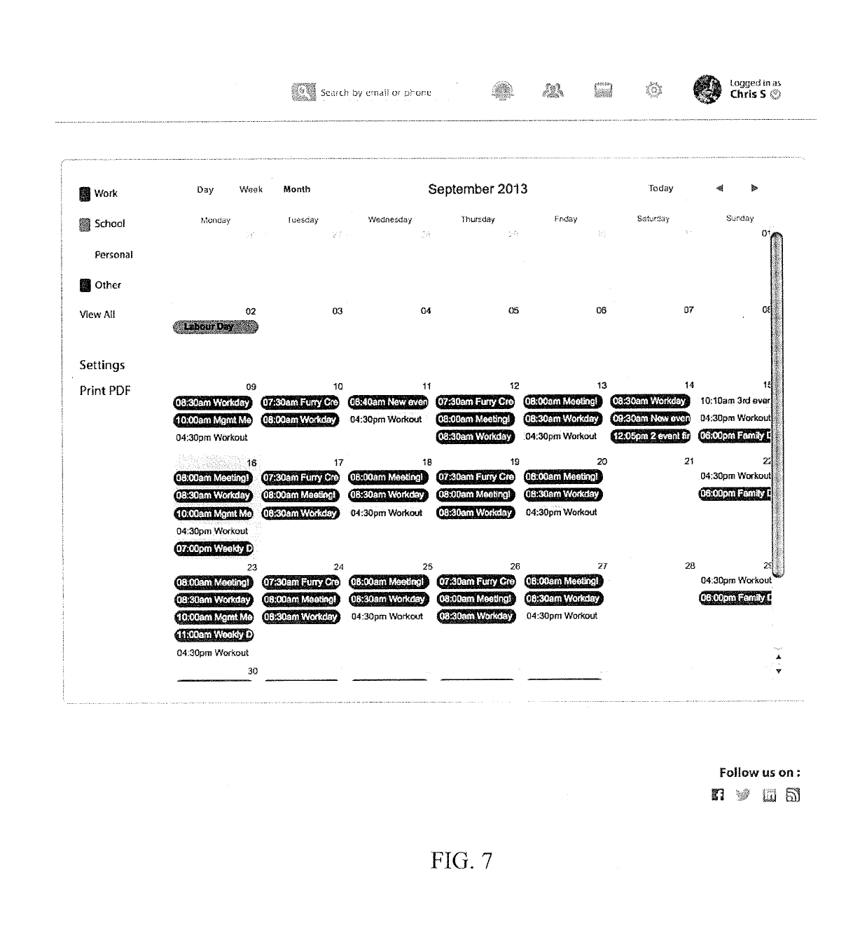

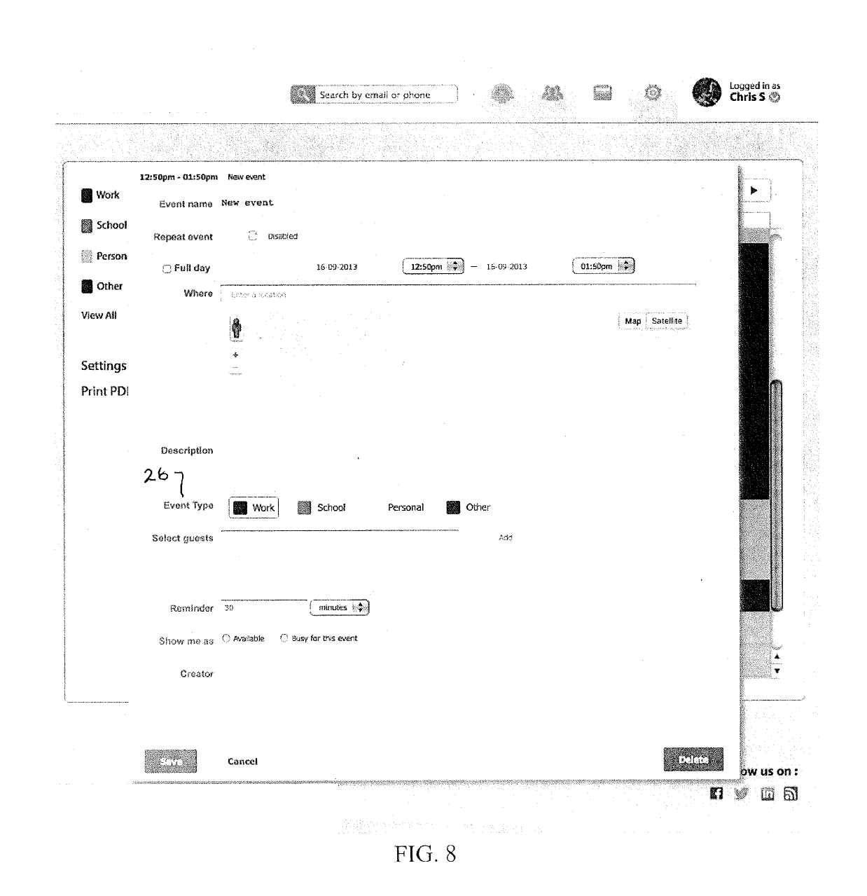

To achieve the above-described functions, an Employee and an Employer (or an Organization), may register with the online System via the System Web Server 12 to become Members, either simply as Members in the first embodiment or as Employee Members (assets) or Employer Members (asset users) in the second embodiment. Each member is assigned a username and password. An Employee Member can see his/her own schedule as shown in FIGS. 5, 6 and 7 on a daily, weekly or monthly calendar as selected by the user. By clicking on a day or time, the user brings up a scheduling screen as shown in FIG. 8. The user selects the event type 26, i.e. work, school, personal or other, enters a name for the event and time, may enter a location using the phone's mapping solution, a description of the event, and may enter an email address(es) of guests to whom an invitation will be sent. The user can set a time period before the event at which a reminder will be sent, and can set the time block to display the user as available or unavailable to another user viewing the calendar. Thus a personal time block might display as time available to an Employer/Organization so the Member can have the option to accept or decline a shift request and change their personal time to be able to take on more work. Alternatively, an Employee Member can choose to set time blocks to display with only time available.

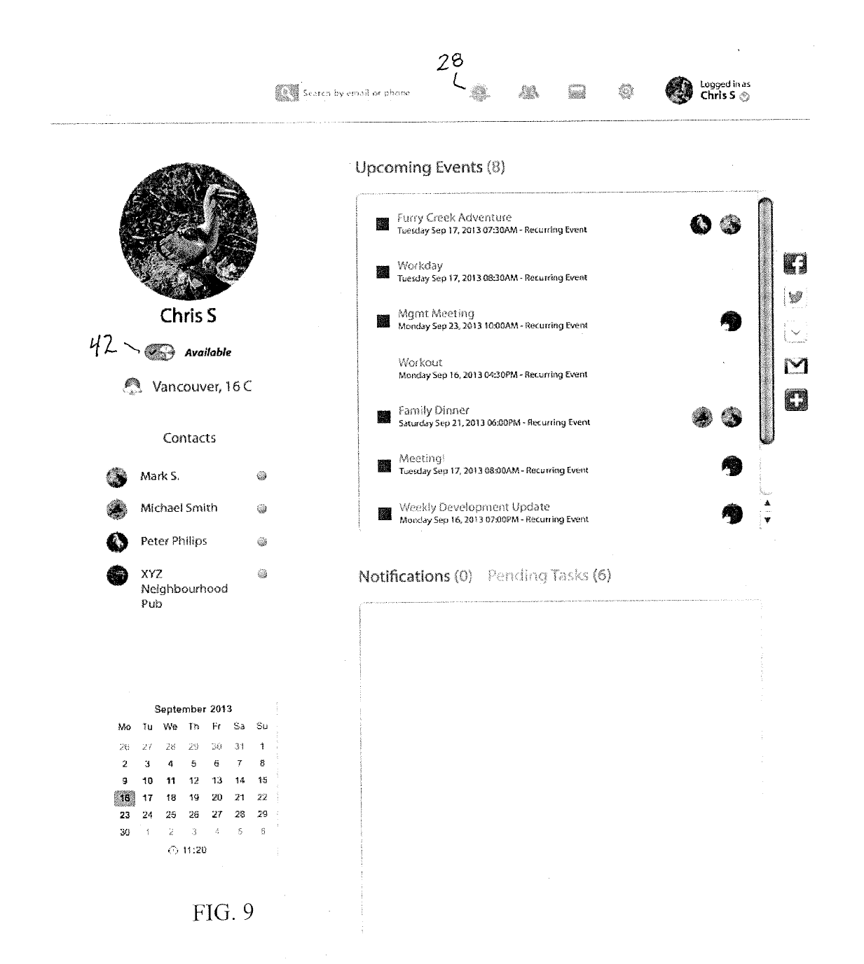

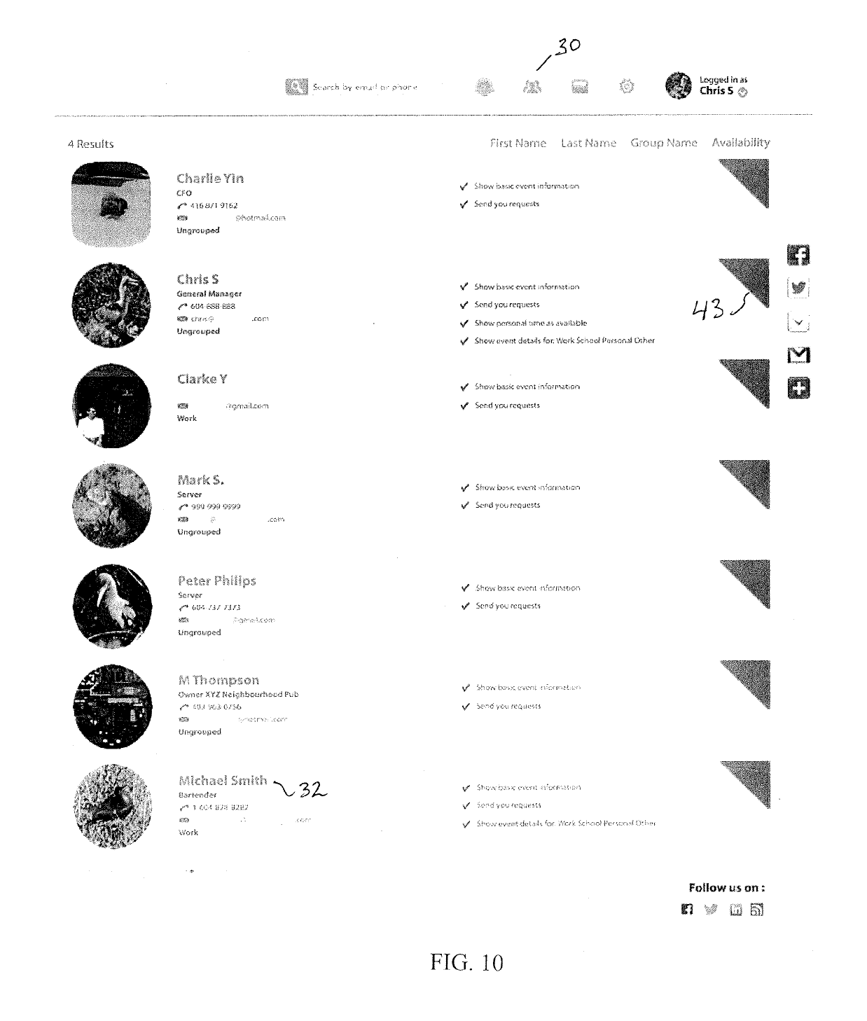

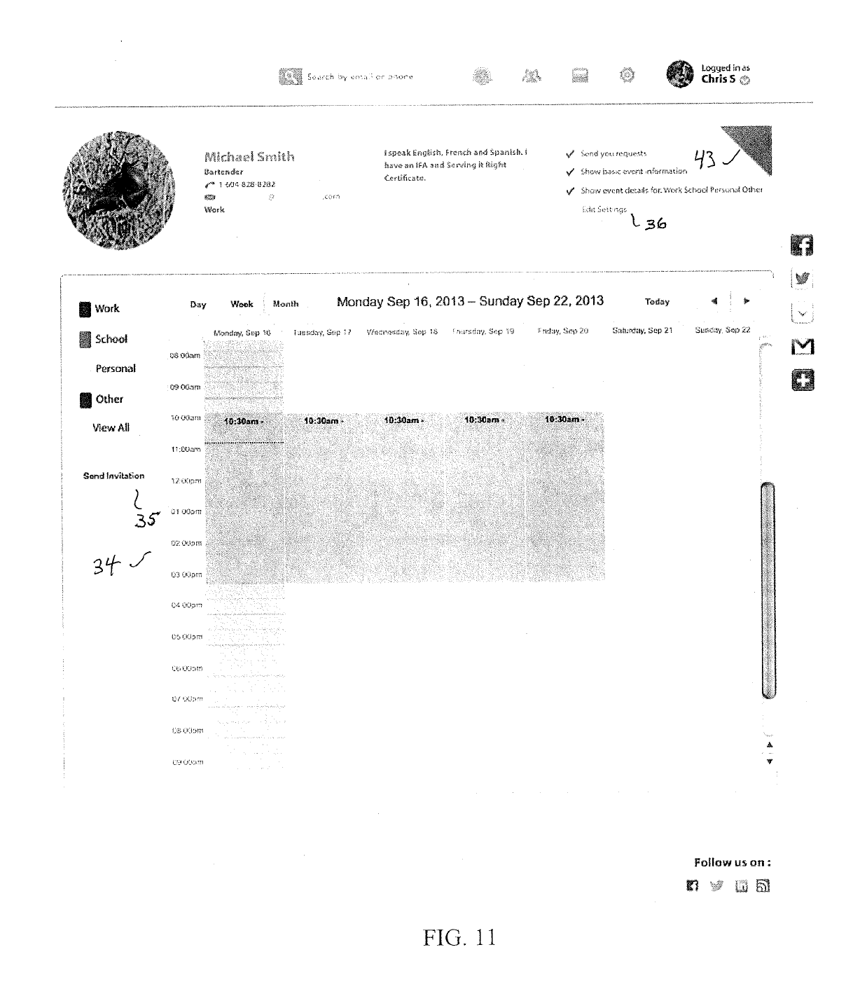

FIG. 9 illustrates the screen shot when the user clicks on the dashboard icon 28. The invention provides two levels of availability, first on the user's calendar view they can select to have personal time entries display to certain others as available. The user also has an immediate availability indicator 42. On the dashboard view, button 42 toggles between available and busy. The immediate availability of the user is then indicated on the contacts list, FIG. 10 by the color green, for example, at 43 and also in the top right corner of each contact profile, shown in FIG. 11. For example it lights up green if the contact is currently available and turns off or changes color, for example to grey when the contact is busy. This therefore provides the real time availability vs scheduled availability. FIG. 10 illustrates the screen shot when the user clicks on the contacts icon 30, which causes the user's contacts to be displayed. Clicking on a specific contact 32 causes that contact's calendar 34 to be displayed as in FIG. 11. In FIG. 11. the time blocks were set by the contact “Michael Smith” to display to this contact with only his availability, without any details. If Michael gave Chris S. permission to see detail of this time block type (say “Work”), the time blocks would be colored and provide details similar to the users own time blocks. The dotted line at 10:45 am Monday, indicates the current time and date when the screen shot was taken. The user can invite that contact to an event by clicking on a ‘send invitation” button 35.

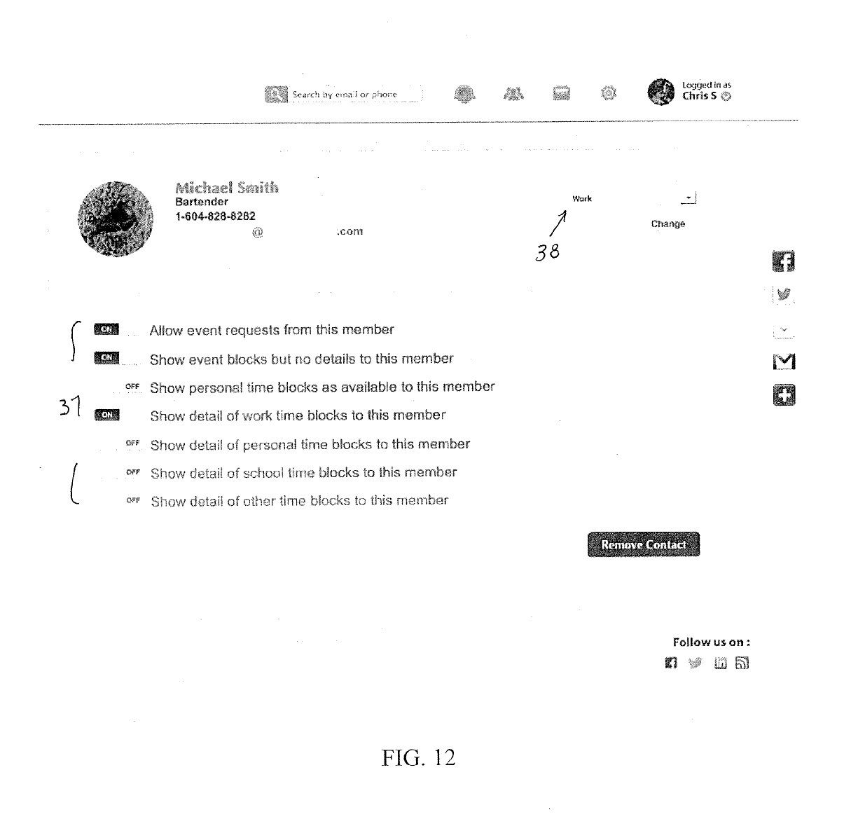

All Members can set rules as to what level of access another Member who is a contact has to his/her schedule by selecting “Edit Settings” 36 on this page shown in FIG. 11, which causes the page in FIG. 12 to be displayed. On this page the user can set permissions/rules as to the level of detail another member can see, enabling or disabling the following inputs 37: I) allowing event requests from that member; ii) showing event blocks but no detail from the user's calendar to this member; iii) showing personal time blocks as available to this member; iv) showing details of work blocks to this member; v) showing details of personal time blocks to this member; vi) showing detail of school time blocks to this member; and vii) showing detail of other time blocks to this member. The contact's group status can also be selected at 38.

In this way the individual user can control the information displayed to other members such as friends, family or employers. For example, an individual may permit family members to view detail on both work and personal time blocks, but restrict an employer from viewing detail on both work and personal time blocks, with only access to availability with no detail as to why the individual is unavailable. Similarly some friends may see detail on personal time blocks, while others may not. The individual can set permissions/rules to determine if another member can send time block/event requests to them, on a per member basis. Members can then see and access the schedule of other Members (either individuals or organizations) they may be connected to, with a level of detail determined by permissions/rules given to them by other Members. These permissions and rules are handled via a Rules Engine.

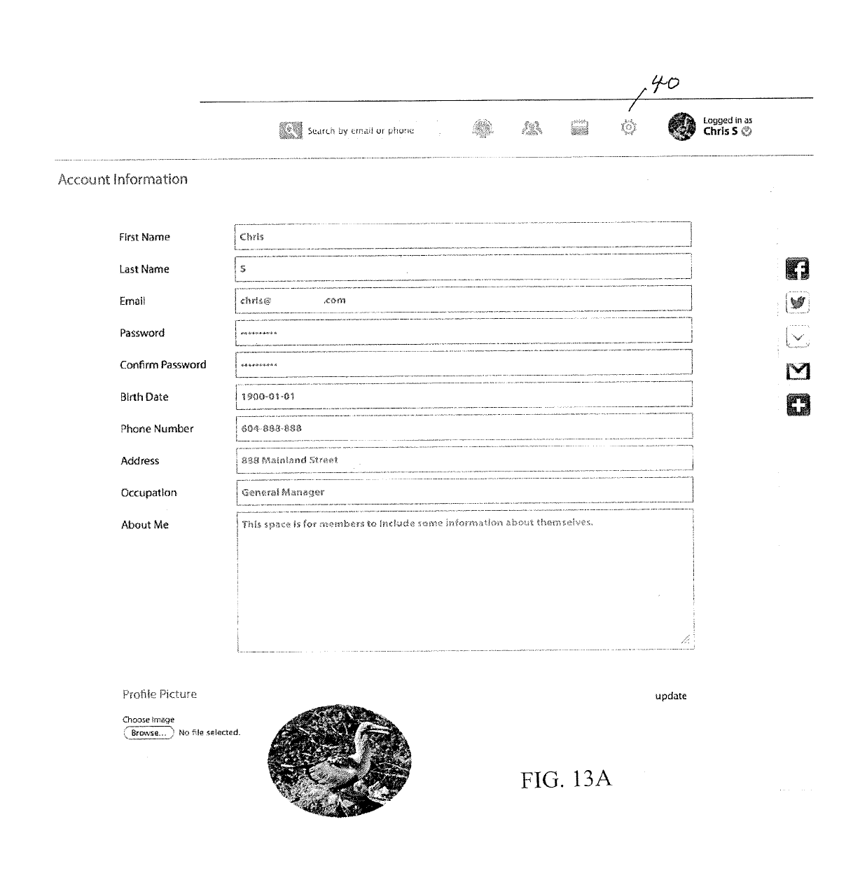

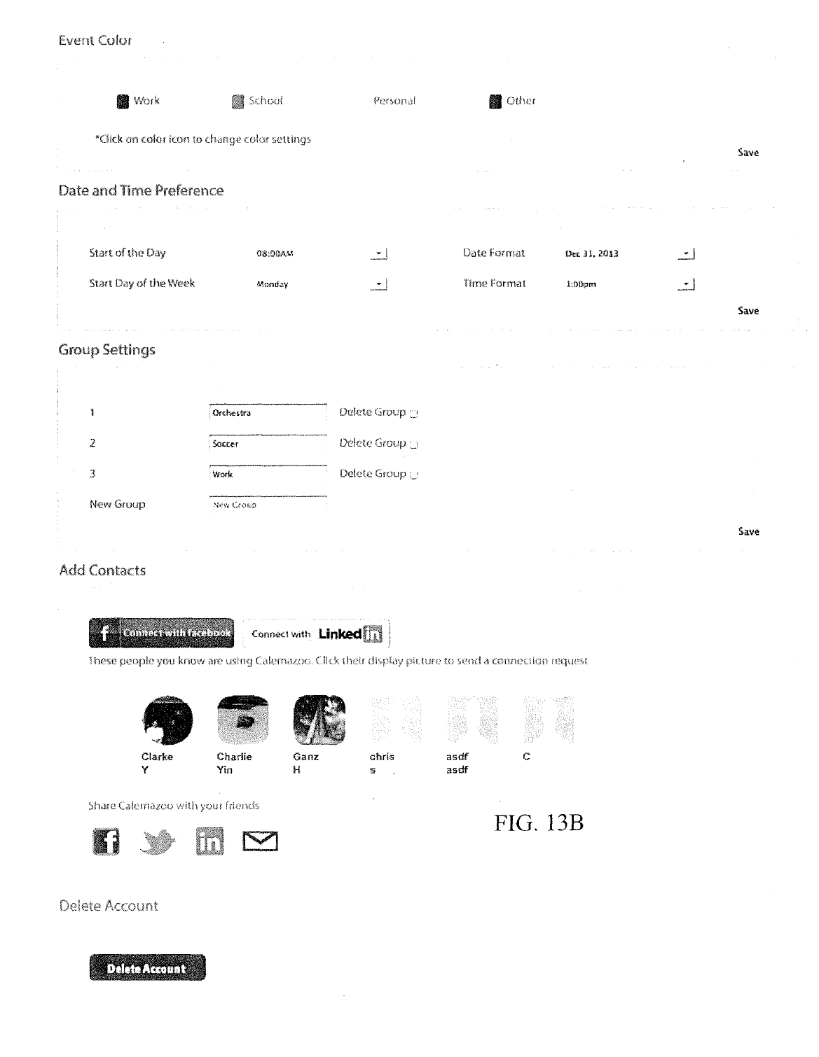

FIG. 13A, 13B illustrates the account settings information page displayed when the user clicks on the settings icon 40. On this page the user can select colour settings for the different event types, define different group types and add contacts. Employees create and manage their own member profile on the system. By doing so, the employee establishes a portable profile that any employer, organization, friend or family member can use to schedule time with them. This profile is transportable between employers using any supported third party staff scheduling software solution.

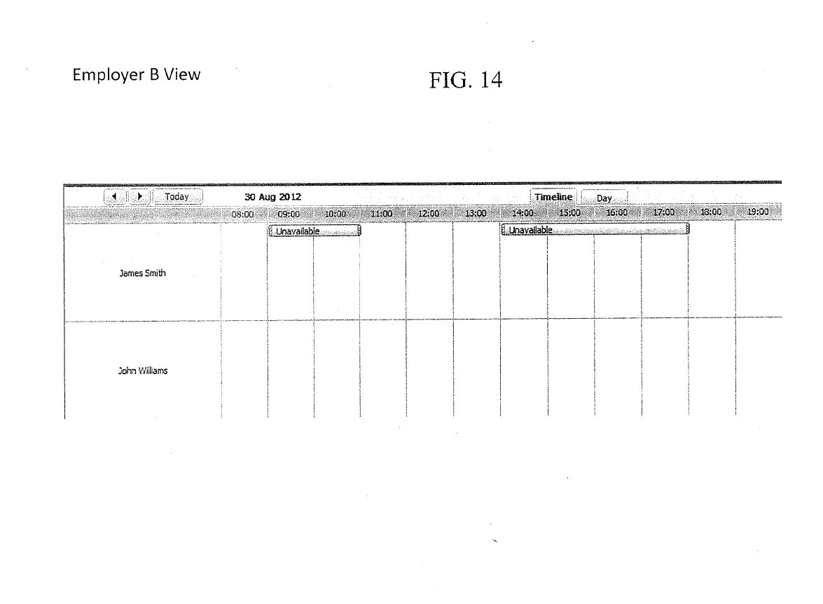

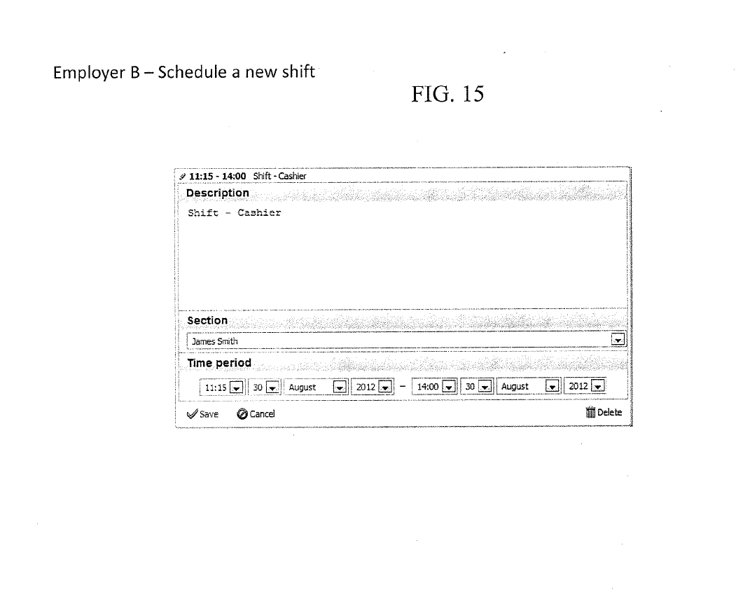

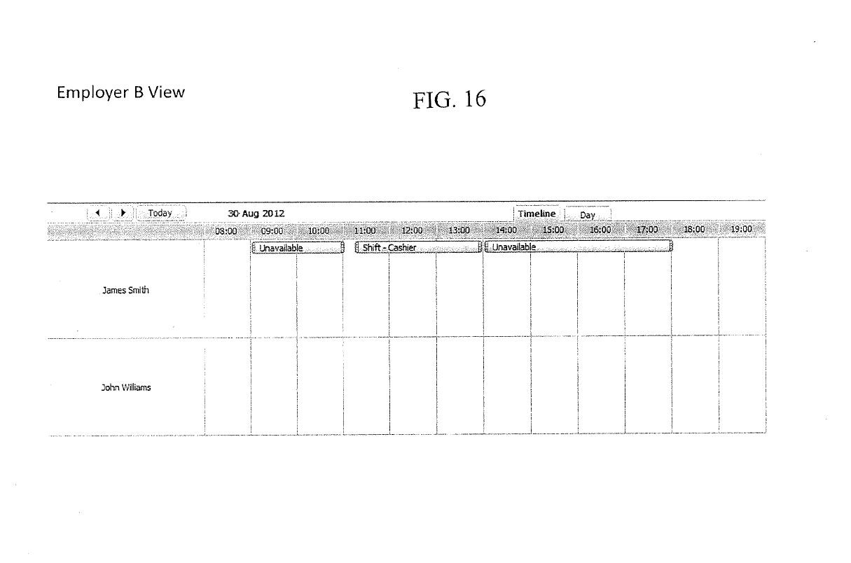

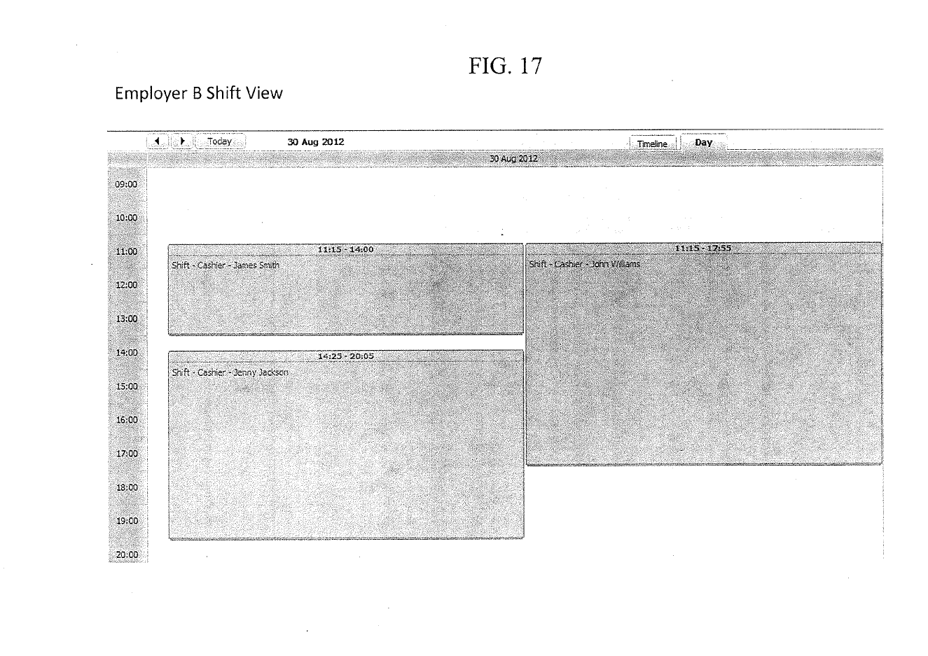

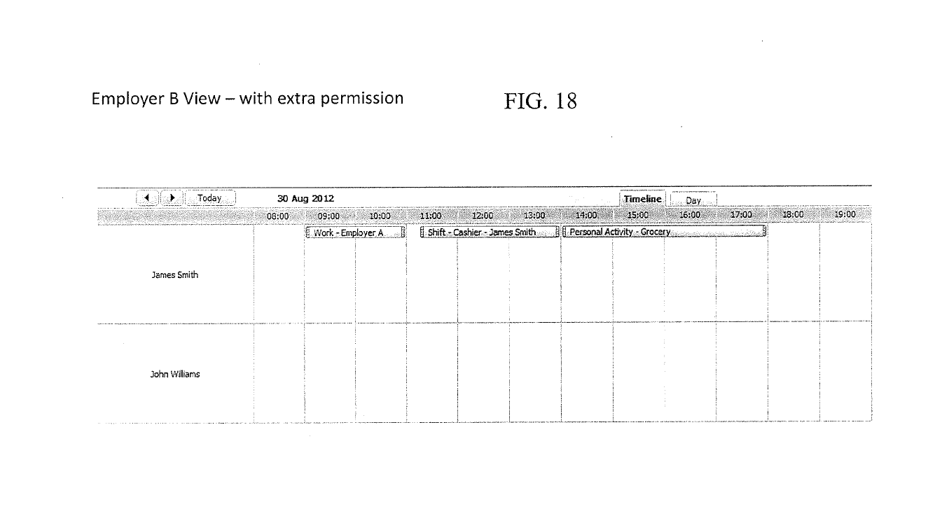

Employers which are Members on the System may therefore be restricted to see only the unavailability (or alternatively the availability), of Employees who are Members which they are connected to. Organizations are able to generate and export a report of all Employees who are Members unavailability or availability for a specified date range using the Internet Browser application or native mobile applications. FIG. 14 illustrates an employer's view, generated by its internal scheduling system, of two employees' calendars where the employee has restricted the display to simply specifying availability. FIG. 15 illustrates the employer scheduling a shift for an employee using the employer's scheduling software. Organizations can set rules about switching shifts, hours of work etc. and the system ensures that only qualified individuals receive shift requests and are scheduled. If an employee cannot take a shift, they indicate so via their mobile phone using the Internet Browser application or native mobile applications, and the scheduling software automatically generates a list of qualified alternates within the organization, with or without a manager's permission, and sends them an available shift notification. The first qualified individual to reply gets the shift, the employee gets notified their shift is covered and the manager receives confirmation of the change. FIG. 16 shows the newly scheduled shift the details of which are viewable by the employer according to the employee's set permissions. FIG. 17 illustrates the calendar view for an employer. Where an employee provides extra permissions to the employer, the employer may see more detail on the employee's calendar, which is exported to the employer's scheduler as in FIG. 18.

Employer A may therefore set up a scheduling account via the system's website 12 or a mobile app, enter list of email addresses of employees into the scheduling system site 12 which sends invitation by email to connect with them on the scheduling system website. If an employee is already a member of the scheduling system, they receive a notification through the system. If already a system member, the employee accepts the link and can now accept, request and manage shifts with the employer. If the employee does not have a system account, the system sends them an invitation via email to join the system and connect with Employer A. The employer sets up the schedule with employee(s) using real time availability information provided by the scheduling system and publishes the workplace schedule. The employee can download mobile apps for iOS and Android devices, and then receives email or push notification that a new schedule has been published. The employee then logs into the scheduling system server to view his/her schedule. The employee then receives schedule changes, sends shift change requests, and manages his/her account. Employer A is able to monitor the status of which employees have joined the system in its contact list. By accepting the request or clicking on the link in the email, employees are added to Employer A's contact list. If an employer is using a supported scheduling software solution it can subscribe to a system API to connect their scheduling system to employees who are members of the system and export the information to their scheduling system. Individuals can thereby accept/decline shift fulfillment requests, send “take my shift” requests, swap shifts and generally manage their schedule with employers.

As system members, employees can then select time block classifications; select permissions associated with the classifications; and enter any scheduled time blocks as required to manage his/her availability. Employer A can obtain a report on the time blocks of each employee and use this information to create a schedule in a system independent of the system calendar (i.e. a third party solution, excel sheet, etc.).

Similarly Employer B then sets up a system account via the system website 12 or the system mobile app, enters list of email addresses of employees into the system and sends invitations to connect with them on the system. Certain individuals accept the request and are then linked to Employer B. Employer B can obtain a report on the time blocks of each employee and use this information to create a schedule in a system independent of the preferred Staff Scheduler. Other employers can do the same with individual employees. The scheduling system provides immediate information on the employee's/asset's availability and reduces scheduling conflicts when multiple stakeholders are trying to schedule shared assets simultaneously.

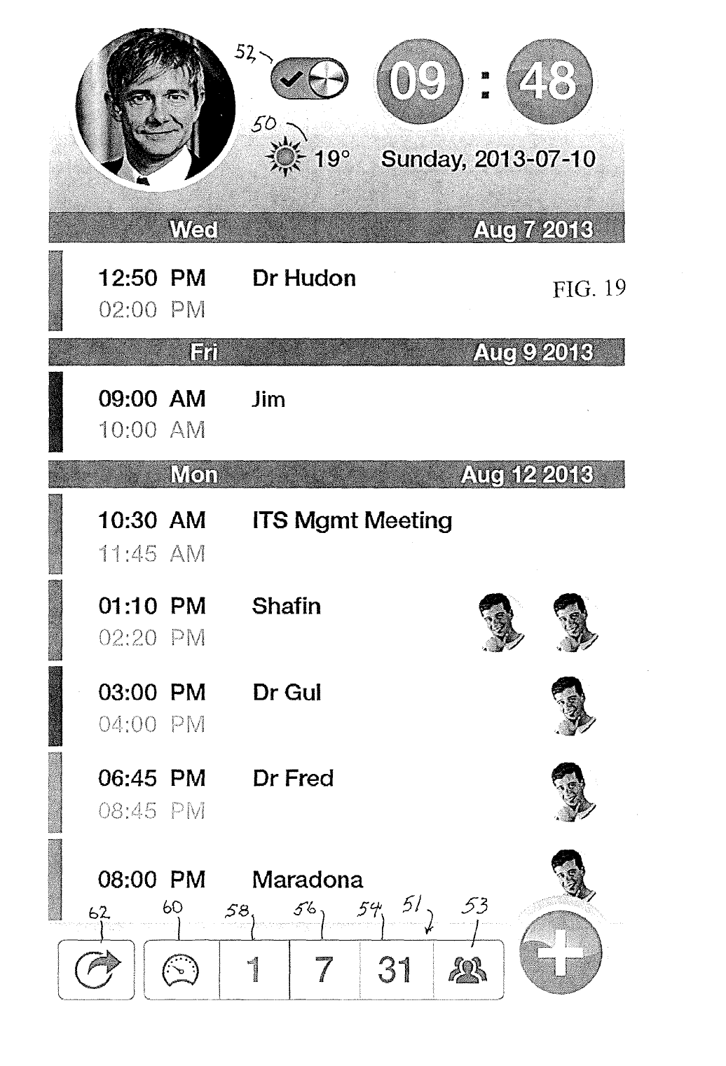

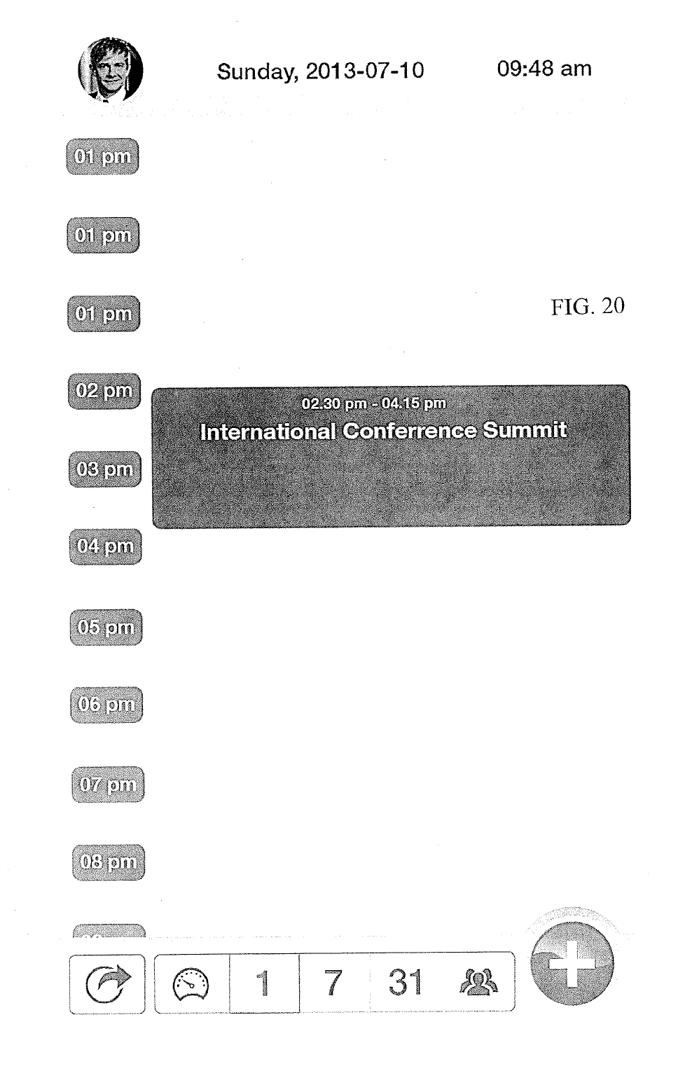

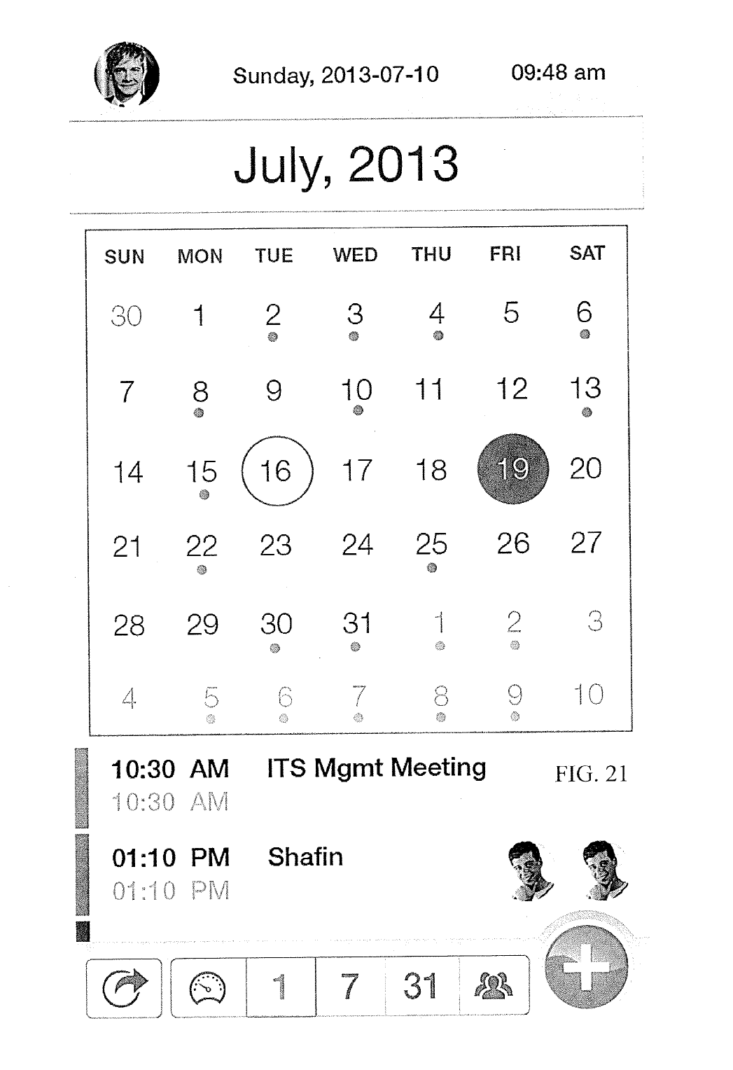

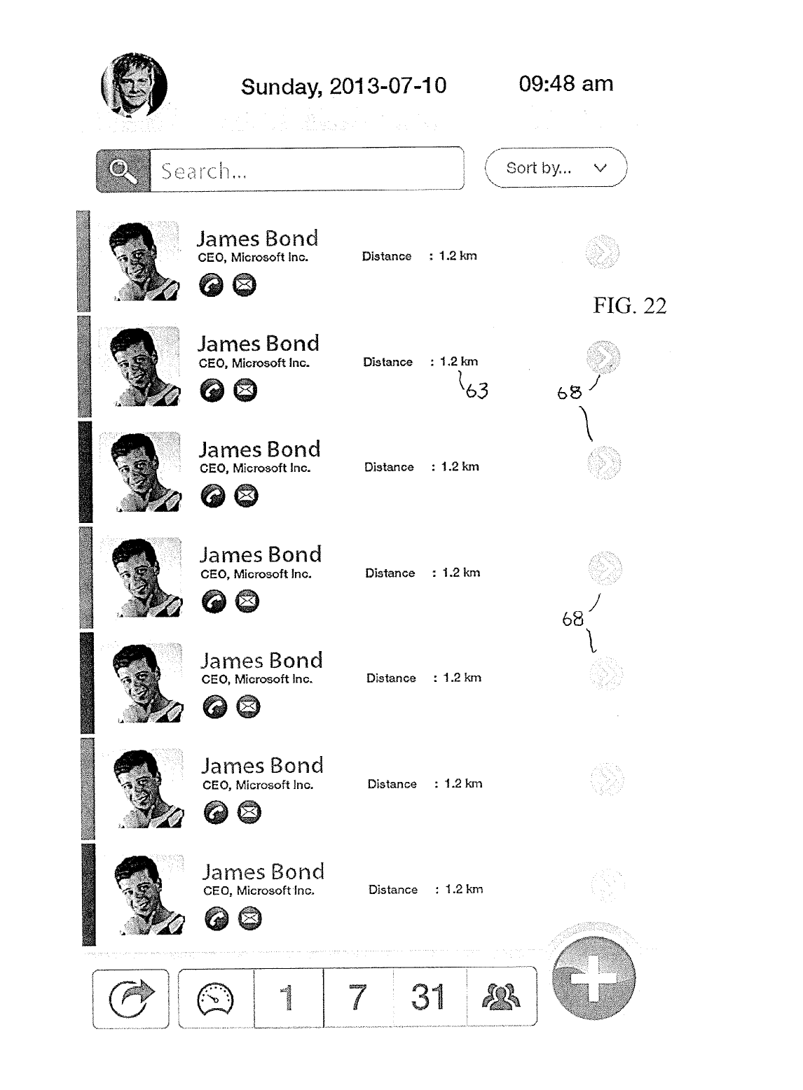

The present invention can function through Mobile device apps, such as iOS or Android native applications, or Windows, Blackberry and/or a Responsive Web App. FIG. 19-28 illustrate the wireframes for the web pages displayed by the mobile app corresponding to the screen shots described above. FIG. 19 is the User's Dashboard View. It includes a weather forecast 50 which the user can click on and see the week's weather forecast, available/busy switch 52, time and date, and navigation buttons in the footer 51 which are common on all pages. These are contact list 53, monthly calendar 54, weekly calendar 56, daily calendar 58, dashboard 60 and menu navigation button 62. FIG. 20 shows the User's Calendar day view. FIG. 21 shows the User's Calendar month view. FIG. 22 shows the User's Contact List view. The availability indicator for each contact may be similar to the web solution described above with the top right corner of a contact's profile lighting up green when available and grey when busy. The contact list view provides at 63 the approximate distance away of every contact using a mobile app with GPS location.

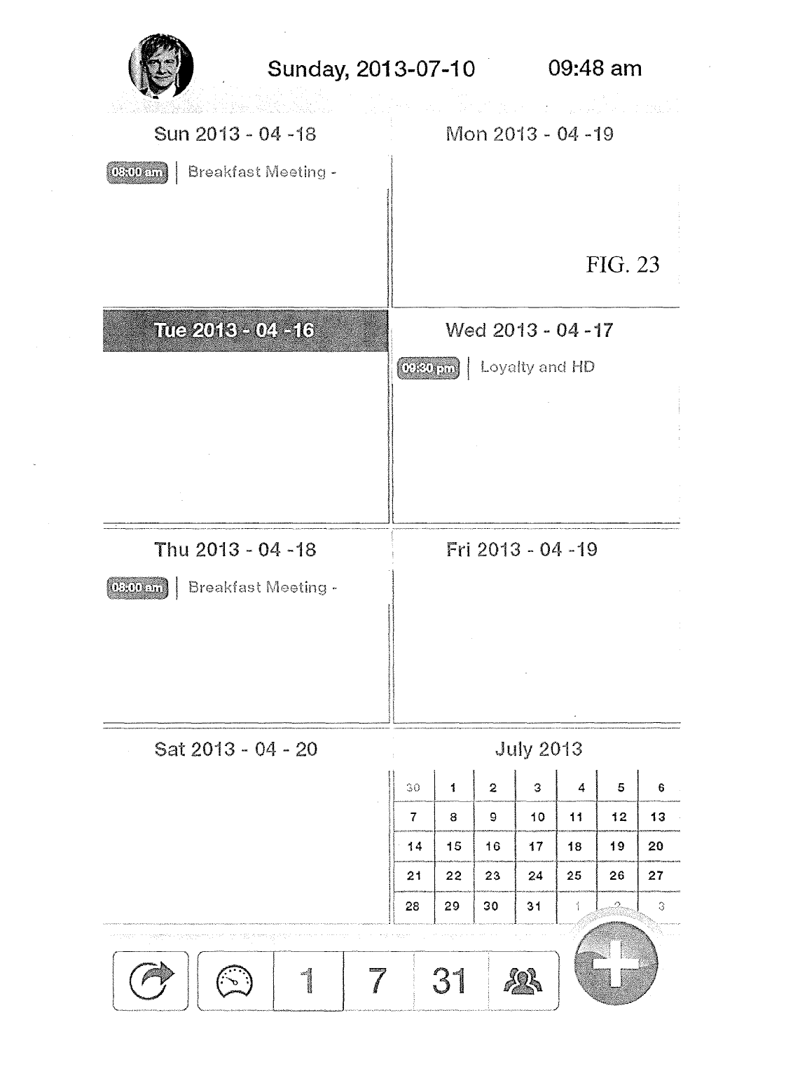

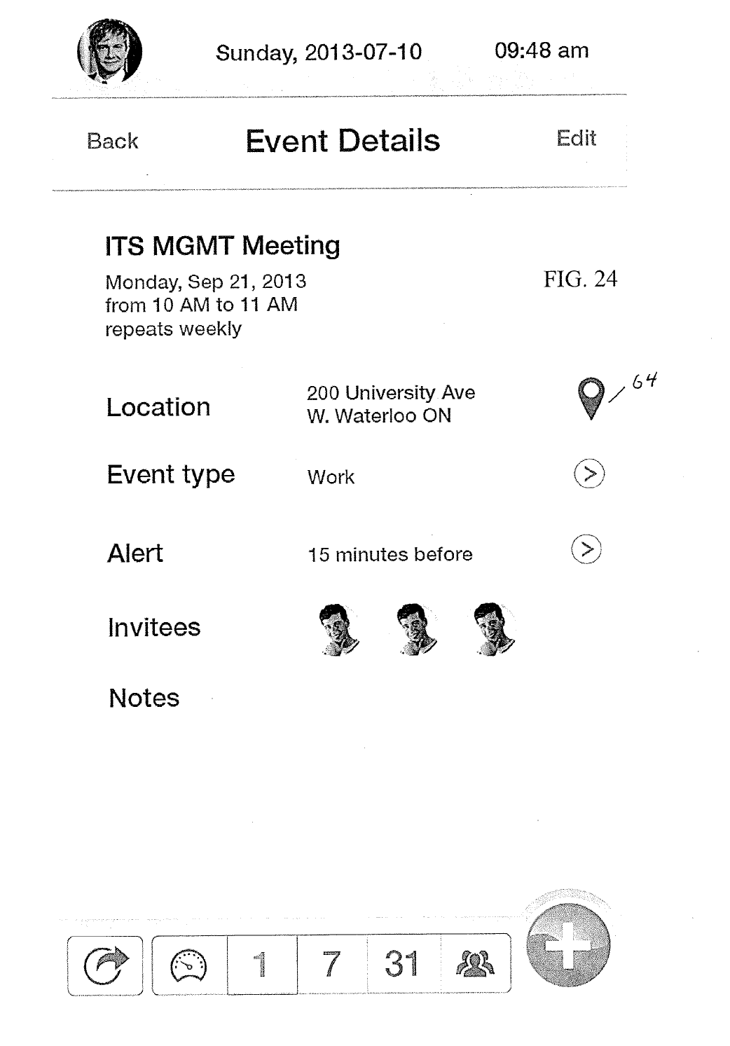

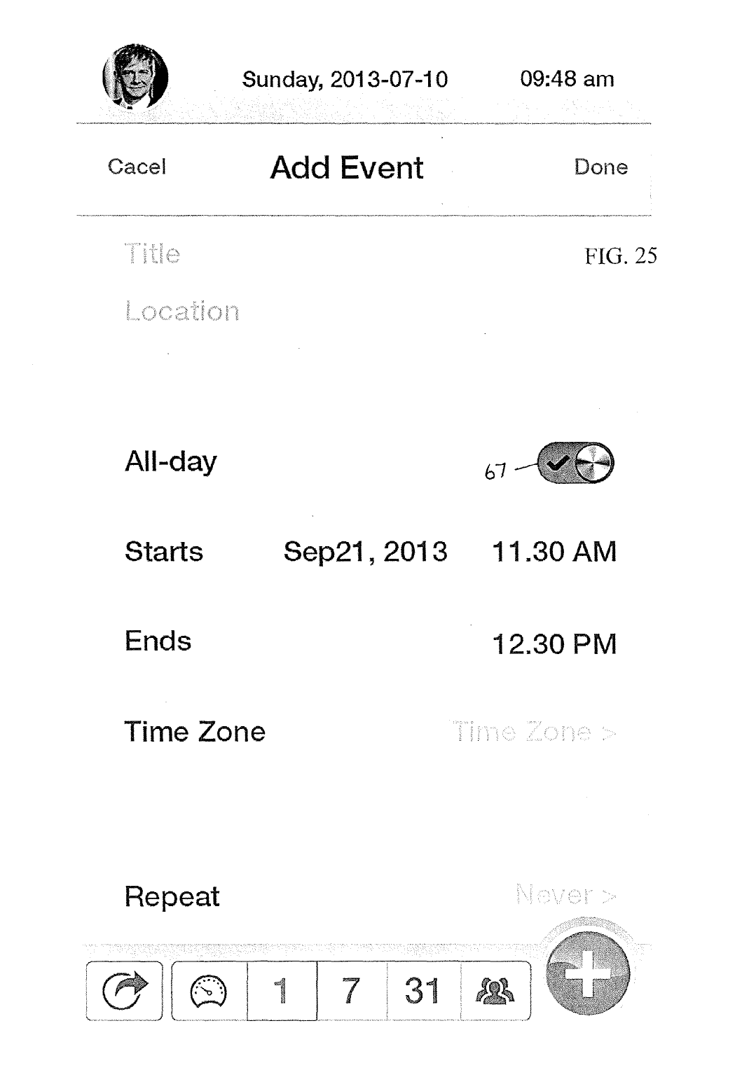

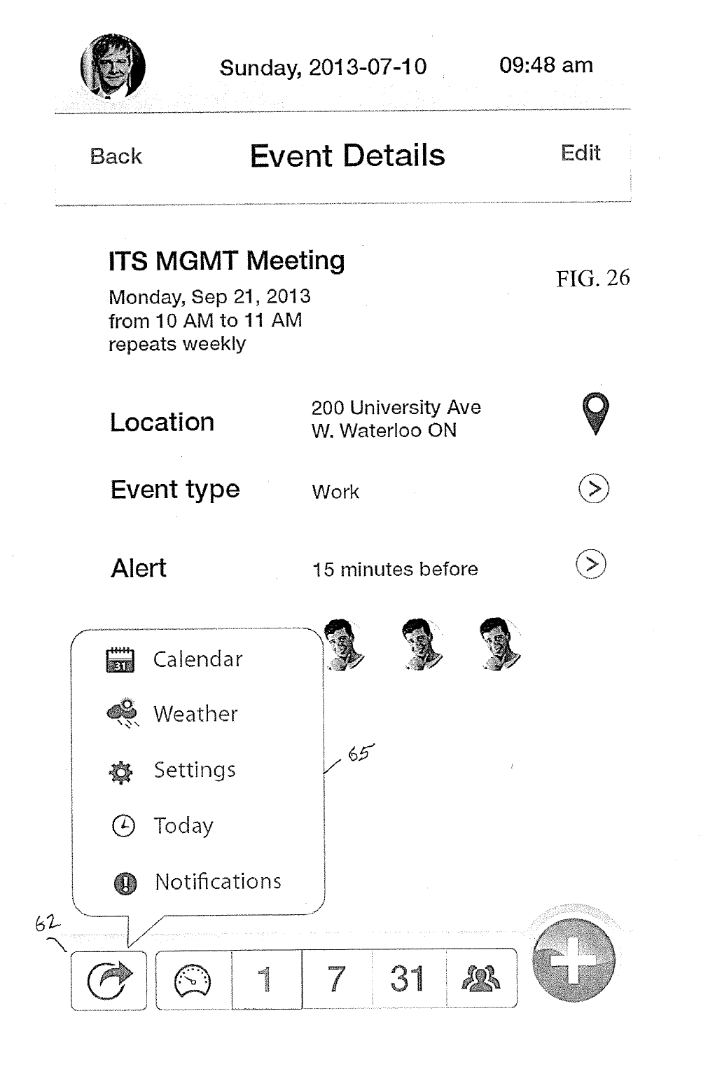

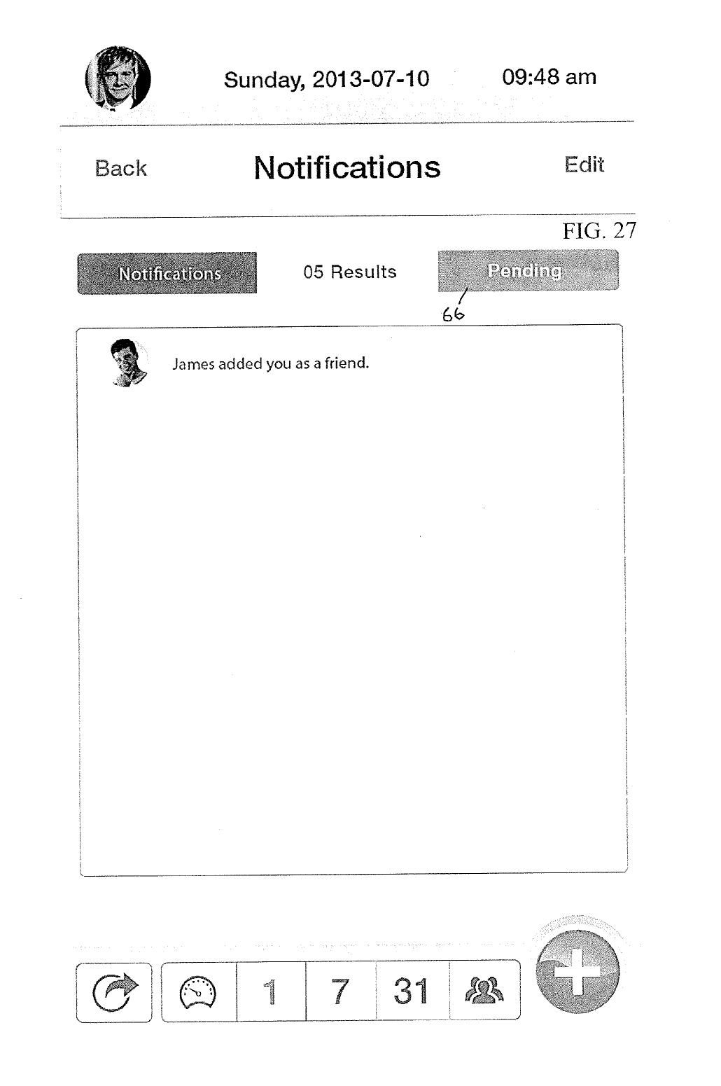

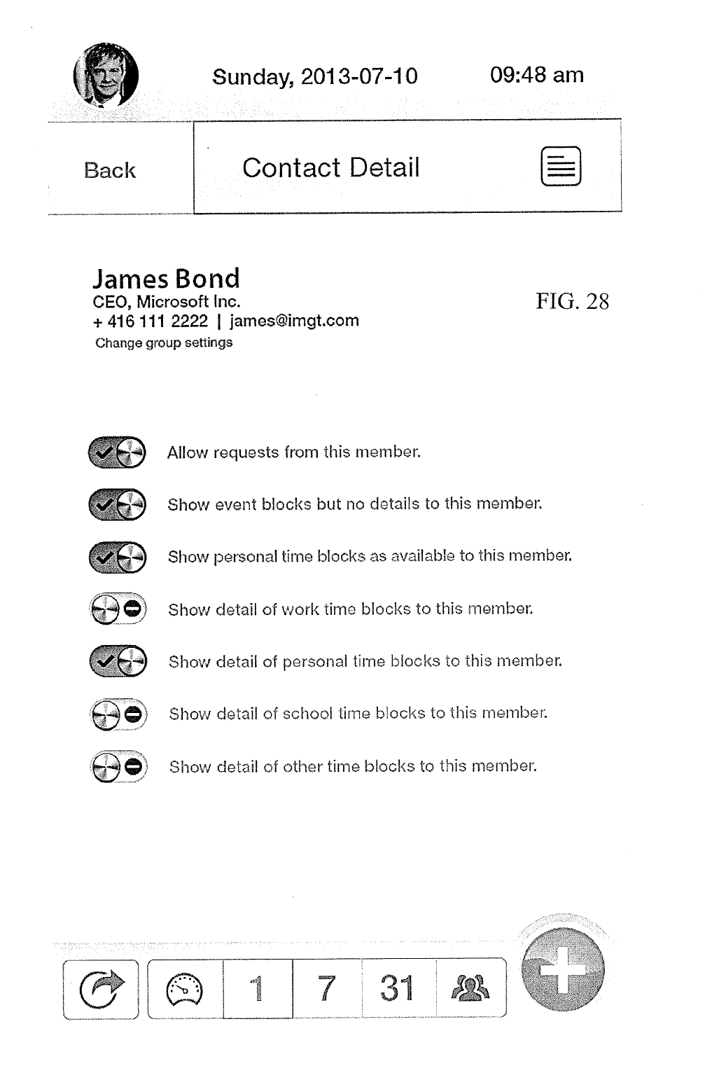

FIG. 23 shows the User's Calendar Week view. FIG. 24 shows the Event Detail View as displayed when the user selects a scheduled event. The app uses a mapping application to locate and display a map showing the location of the event when the user clicks on icon 64. FIG. 25 illustrates the Add Event view which is displayed when the user clicks on an open calendar date, with availability indicator 67. FIG. 26 shows the Event Detail view as in FIG. 23 in which the menu pop up 65 for the menu navigation button 62 is displayed, including access to a monthly Calendar view filter, the week's weather forecast, the settings page, access to today's schedule, and access to Notifications page view. FIG. 27 shows the Notifications page view with toggle 66 between New and Pending notifications. FIG. 28 illustrates the Contact Detail page on which the user defines permission settings. It is displayed when the user selects button 68 for a contact in the Contacts page shown in FIG. 22.

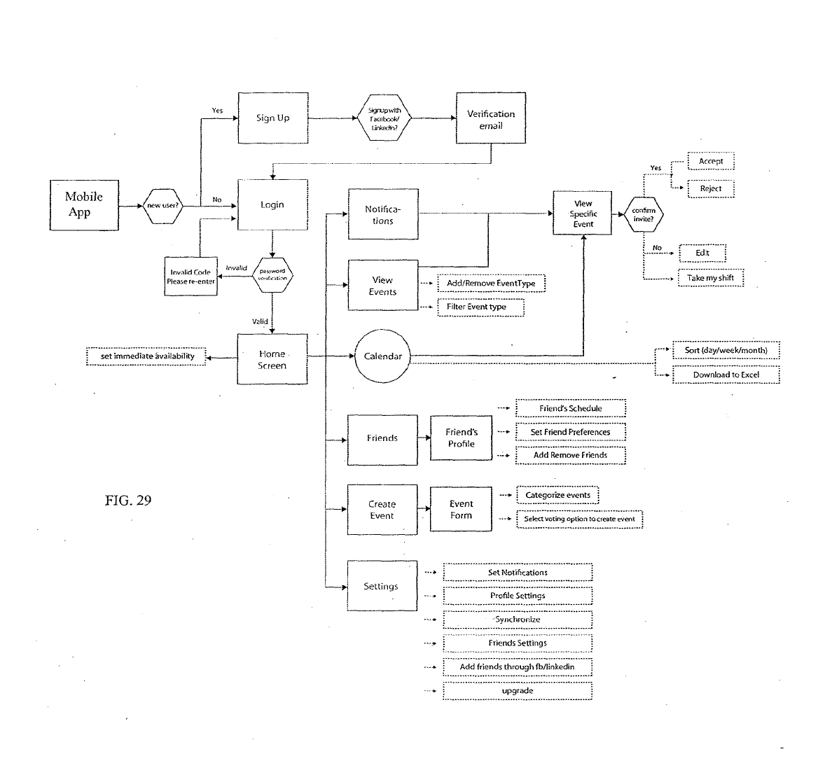

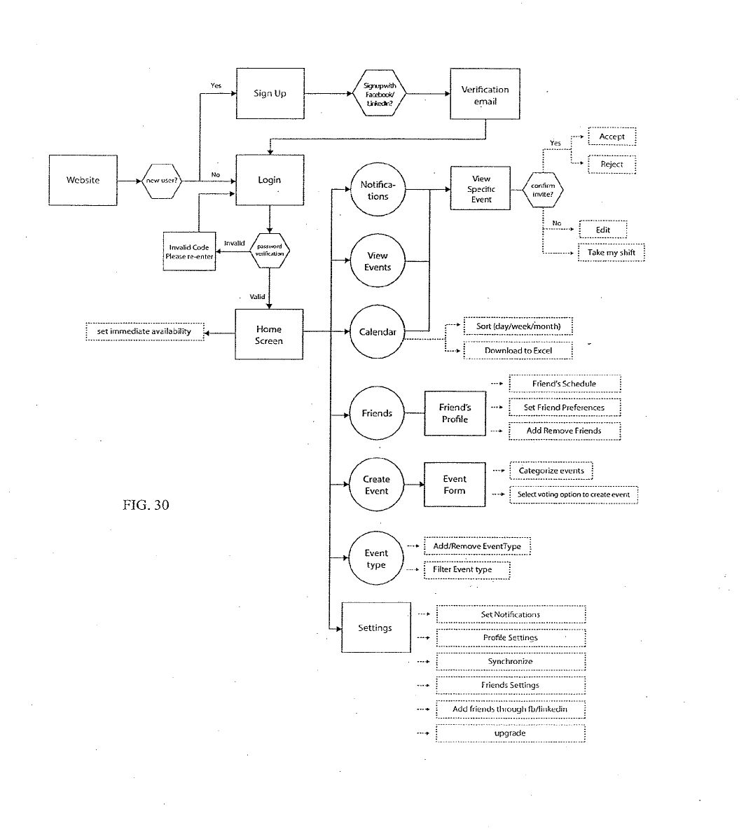

FIGS. 29 and 30 are flowcharts illustrating the user's interaction with the system for a mobile application and web-based application respectively. Rectangular boxes illustrate a screen display, hexagonal boxes are decision points, circular boxes are features within a page and dotted rectangles illustrate functions. As shown, in both applications the new user proceeds through a sign-up procedure, whereas existing users login and are served up the home screen. In the web app the home screen displays various features, namely notifications, view events, calendar, friends, create event and event type. In the mobile app only the calendar is a feature on the home screen whereas the other features are served up as separate screens. From the calendar the user can select to view a specific event and is taken to that screen from which the user can accept or reject an invitation to attend a particular event.

The Mobile app uses the GPS location services provided by the user's mobile device to allow a user to map and find directions to a location of an event. A user can select the location icon and be taken to their map application to map the location and get directions from their current location. In addition, the GPS Location Services on mobile phones can be used to provide a user the approximate distance to the contact's location from the user's current location if both the contact and user have their location services turned on By the contact list view providing the approximate distance away of every contact using a mobile app, this feature could be useful for managers to be able to see how far away an employee is in the event they have not shown up for a shift or when considering who to call in for a last minute shift. If two or more employees are “available” but one is significantly closer than the other(s), they can select who to call in based on how fast they could get there.

Other contextual features include the ability to click on the phone or email icon (in a contact's profile) and access the phone or email application on a users phone without having to type in the phone number or enter an email address. The mobile app will also sync with the user's contact list in their web application to identify those contacts using the system for easier connectivity.

After selecting a date for the event, the system has the option to provide a list of people that are available for the event based on a users contact list. After selecting the invitees to an event, the system is able to suggest a number of dates and times where everyone is available. The system allows for additional information to be stored within each days record of events such as the weather, expenses, hours worked, revenue earned, emails sent/received, routes traveled, etc. by linking other third party applications to create a historical record of each day in a users calendar/schedule. A user can then go back in time, select any day and access all records and accounting for that day.

A social network based on time schedules can be set up using the invention. An individual sets up a system member account and invites others to connect with them on the system and share their schedules. That can include friends, family, associates and organizations. As system members, such persons can select time block classifications; select permissions associated with the classifications; and enter any scheduled time blocks as required to manage his/her availability. Such persons can send out invitations to join the System, share status and availability via other social networks (Facebook, LinkedIn, Google+). Persons can send event requests to another member or members they are connected with on the system, and can accept and decline event requests from other members they are connected with on the System

The invention can also be used by schools, teachers, support staff and students, to connect faculty, support services and the student body with each other, to more efficiently manage shared resources, communicate and share events, schedules and availability. The invention can in the same way be used by businesses for managing and scheduling physical assets and resources, for example equipment. Maintenance Managers can manage availability of physical assets and resources using the System. Organization Managers can schedule shared physical assets and resources using the System. Organizations can also use the preferred scheduling application and the System for managing and scheduling fleets of equipment such as vehicles and aircraft. Whereas Fleet Managers manage availability of fleets of equipment and assets using the System, Organization Managers can schedule shared equipment and assets using their scheduling application

The invention therefore provides I) the ability to create a free member profile, update and share contact information; ii) the ability to invite social network, family and organizations to become members; iii) the ability to connect with other members; iv) the ability to set permission levels for individual member's access to profile; v) the ability to create individual time blocks, re-occurring daily, weekly and monthly time blocks and in general edit and manage availability; vi) the ability to view and modify personal schedule; vii) the ability to view availability of other members to whom one is connected; viii) the ability to view approximate distance away of other members to whom one is connected.

When connected to the employer's preferred scheduling application, there is provided I) the ability to accept or decline shift/event requests; ii) the ability to make shift requests, swap shifts, notify in case of sick or inability to make shift/event and facilitate schedule changes. Facebook, LinkedIn and Google+ integration, Windows and Blackberry native app and/or a responsive web app integration can be provided for added convenience, as are Downloadable Android and iOS mobile apps; iii) the ability to send, accept and decline event requests with members one is connected to; iv) the ability to sync with Google and iCal personal calendars; v) the ability to upload a profile picture or in the case of an organization, a logo; vi) the ability to upload skills, certificates, etc. (i.e. a mini resume) or a corporate bio; APIs for other leading staff scheduling solutions

Individual members become ambassadors to the solution and introduce the system to employers and organizations they work with as a convenient way to communicate their availability. The system therefore provides an employee-centric approach suited for a part time, casual and independent workforce. Currently there is no staff scheduling solution that can allow an employee to manage their schedule with multiple employers and other stakeholders simultaneously. The system allows managers to create schedules and publish them online. Employees can check their schedule, update their availability and even swap shifts from any Internet connected device, lowering the management burden and creating efficiencies. Employees no longer have to call in to ask “Am I working?” Instead, all their schedule details are available through the system, with real time accuracy.

While the system has been described as applying to Employees it is also equally applicable to Individual Members or Independent Contractors, and also is useful for scheduling other time-restricted assets such as rental cars, rental tools and the like.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are within their true spirit and scope.

What is claimed is:

1. A method of scheduling, over a computer network, a time-limited asset, such as an employee, among a plurality of users of the asset, such as employers, where said asset and plurality of asset users have access to the internet, the method comprising:
i) providing a scheduling server accessible to the internet and to a web server for displaying information to said asset and asset users;
ii) providing a database for storing scheduling information;
iii) said scheduling server maintaining a scheduling calendar for said asset which is accessible to said asset, has controlled access to said asset users, by receiving scheduling information from said asset;
iv) said scheduling server receiving from one of said plurality of asset users a scheduling invitation;
v) said scheduling server saving said invitation to said database;
vi) said scheduling server communicating said invitation to said asset;
vii) said scheduling server receiving from said asset an acceptance or refusal of said invitation;
viii) said scheduling server updating said asset's calendar and informing said one of said plurality of asset users of the scheduling;
ix) said server repeating steps iv) through viii) for additional invitations for said asset scheduling;
wherein more than one asset user can access said asset's availability on said calendar simultaneously.

2. The method of claim 1 wherein said asset is an employee and said asset users are a plurality of employers.

3. The method of claim 2 wherein said employee accesses the system using a mobile application having GPS capability and the approximate distance away of said employee from said employer is displayed to said employer.

4. The method of claim 2 wherein said employee provides an indication of current immediate availability or lack of immediate availability as well as future availability on said calendar which is accessible to said employers.

5. The method of claim 1 wherein said asset is an individual and said asset users are selected from the group consisting of organizations, departments, groups, units, friends, family and those with whom said individual might associate.

6. The method of claim 1 wherein said scheduling server receives calls from said asset to view said asset's own calendar; insert a new event in said calendar; edit an existing event in said calendar; delete an existing event from said calendar; accept an invitation; decline an invitation; set permissions for said calendar and allow an asset user to view or export the schedule data from said calendar.

7. The method of claim 1 wherein said scheduling server restricts access of said asset users to limited information on said asset scheduling calendar based on permissions selected by said asset.

8. The method of claim 7 wherein said scheduling server restrictions are selected from the group consisting of I) allowing event requests from said asset; ii) showing event blocks but no detail from the asset's calendar to a user; iii) showing personal time blocks as available to a user; iv) showing details of work blocks to a user; v) showing details of personal time blocks to a user; vi) showing detail of school time blocks to a user; and vii) showing detail of other time blocks to a user.

9. The method of claim 2 wherein each said employer comprises a computerized scheduling application said scheduling server provides an interface to communicate with each said scheduling application.

10. A computer readable storage medium having program code stored thereon, wherein the program code, when executed by a scheduling server accessible to a computer network and comprising a database for storing scheduling information, provides scheduling, over said computer network, of a time-limited asset, such as an employee, among a plurality of users of the asset, such as employers, where said asset and plurality of asset users have access to the internet, performs the following tasks:
i) maintains a scheduling calendar for said asset which is accessible to said asset and has restricted access to said asset users, by receiving scheduling information from said asset;
ii) receives from one of said plurality of asset users a scheduling invitation;
iii) saves said invitation to said database;
iv) communicates said invitation to said asset;
v) receives from said asset an acceptance or refusal of said invitation;
vi) updates said asset's calendar and informing said one of said plurality of asset users of the scheduling; and
vii) repeats steps I) through vi) for additional invitations for said asset scheduling;
wherein more than one asset user can access said asset's availability on said calendar simultaneously.

11. The computer readable storage medium of claim 8 wherein said asset is an employee and said asset users are a plurality of employers.

12. The computer readable storage medium of claim 8 wherein said asset is an individual and said asset users are selected from the group consisting of organizations, departments, groups, units, friends, family and those with whom said individual might associate.
